(19) United States
(12) Patent Application Publication
(10) Pub. No.: US 2012/0191744 A1
(43) Pub. Date: Jul. 26, 2012

(54) DETECTING SEARCH MODE IN A BROWSER NAVIGATION BAR

(75) Inventors: Jane T. Kim, Seattle, WA (US); Warren G. Stevens, Redmond, WA (US); Laura J. Gehring, Bellevue, WA (US); Sarah J. Bowers, Snohomish, WA (US); Pui Ching Hon, Bellevue, WA (US); Clint C. Jorgenson, Carnation, WA (US); Mary-Lynne Williams, Seattle, WA (US); Jason W. Upton, Sammamish, WA (US); Robert J. Mauceri, JR., Seattle, WA (US); Fergal M. Burke, Redmond, WA (US); Martin J. Hall, Seattle, WA (US)

(73) Assignee: MICROSOFT CORPORATION, Redmond, WA (US)

(21) Appl. No.: 13/011,059

(22) Filed: Jan. 21, 2011

(51) Int. Cl. G06F 17/30

(52) U.S. Cl. 707/767; 707/E17.014

(57) ABSTRACT

Various embodiments are directed to providing users with more control over their navigation privacy, while offering robust search experiences through a web browser's address bar. In one or more embodiments, a web browser's search suggestion functionality is turned off by default. Users may choose to opt into the search suggestion functionality so that search suggestions can be provided to them when they enter search terms in the browser's address bar. In one or more embodiments, the status of search suggestion functionality is conveyed to the user so that they understand that their keystrokes are being provided to a search provider so that search suggestions can, in turn, be provided back to the web browser.

### BACKGROUND

Some web browsers use the address bar to enable not only navigation, as by allowing a user to enter a URL, but searching as well as by allowing a user to enter search terms. When the user enters search terms in the address bar, the content that is typed into the address bar can be sent to a search provider, as the user types, to enable the search provider to provide suggestions that are displayed in a drop-down menu adjacent the address bar. This type of functionality can, however, lead to privacy concerns because a search provider can track web addresses that a user visits when they navigate by typing in a URL to the address bar.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments are directed to providing users with more control over their navigation privacy, while offering robust search experiences through a web browser's address bar.

In one or more embodiments, a web browser's search provider search suggestion functionality is turned off by default. Users may choose to opt into the search provider search suggestion functionality so that search suggestions can be provided to them by the search provider when they enter search terms in the browser's address bar. In one or more embodiments, the status of the search provider search suggestion functionality is conveyed to the user so that they understand that their keystrokes are being provided to a search provider so that search suggestions can, in turn, be provided back to the web browser.

In various other embodiments, instrumentality is provided in which a user can specifically and explicitly enter either a navigation mode in which no information is sent to a search provider, or a search mode in which search information is provided to a search provider that can then return suggestions to the web browser.

In various other embodiments, functionality is provided to enable a search query to continue within a browser window when, for example, a user changes browser modes or returns to the address bar to further their search.

### BRIEF DESCRIPTION OF THE DRAWINGS

The same numbers are used throughout the drawings to reference like features.

FIG. 1 illustrates an operating environment in which various principles described herein can be employed in accordance with one or more embodiments.

FIG. 2 is an example web browser user interface in accordance with one or more embodiments.

FIG. 3 is an example web browser user interface in accordance with one or more embodiments.

FIG. 4 is an example web browser user interface in accordance with one or more embodiments.

FIG. 5 is a flow diagram that describes steps in a method in accordance with one or more embodiments.

FIG. 6 is an example web browser user interface in accordance with one or more embodiments.

FIG. 7 is a flow diagram that describes steps in a method in accordance with one or more embodiments.

FIG. 8 is an example web browser user interface in accordance with one or more embodiments.

FIG. 9 is a flow diagram that describes steps in a method in accordance with one or more embodiments.

FIG. 10 illustrates an example system that can be utilized to implement one or more embodiments.

### DETAILED DESCRIPTION

Overview

Various embodiments are directed to providing users with more control over their navigation privacy, while offering robust search experiences through a web browser's address bar.

In one or more embodiments, a web browser's search provider search suggestion functionality is turned off by default. Users may choose to opt into the search provider search suggestion functionality so that search suggestions can be provided to them by the search provider when they enter search terms in the browser's address bar. In one or more embodiments, the status of the search provider search suggestion functionality is conveyed to the user so that they understand that their keystrokes are being provided to a search provider so that search suggestions can, in turn, be provided back to the web browser.

In various other embodiments, instrumentality is provided in which a user can specifically and explicitly enter either a navigation mode in which no information is sent to a search provider, or a search mode in which search information is provided to a search provider that can then return suggestions to the web browser.

In various other embodiments, functionality is provided to enable a search query to continue within a browser window when, for example, a user changes browser modes or returns to the address bar to further their search.

In the discussion that follows, a section entitled “Operating Environment” is provided and describes one environment in which one or more embodiments can be employed. Following this, a section entitled “Example Embodiments” describes example embodiments. Next, a section entitled “Opting-In To Search Suggestions” describes how search suggestion functionality can be opted into in accordance with one or more embodiments. Following this, a section entitled “Explicit Navigation Mode” describes how a navigation mode can be explicitly selected over a search mode in accordance with one or more embodiments. Next, a section entitled “Explicit Search Mode” describes how a search mode can be explicitly selected over a navigation mode in accordance with one or more embodiments. Following this, a section entitled “Continuing a Search” describes how a search can be continued in accordance with one or more embodiments. Last, a section entitled “Example System” describes a system that can be utilized to implement one or more embodiments.

Consider now an example operating environment in which one or more embodiments can be implemented.

Operating Environment

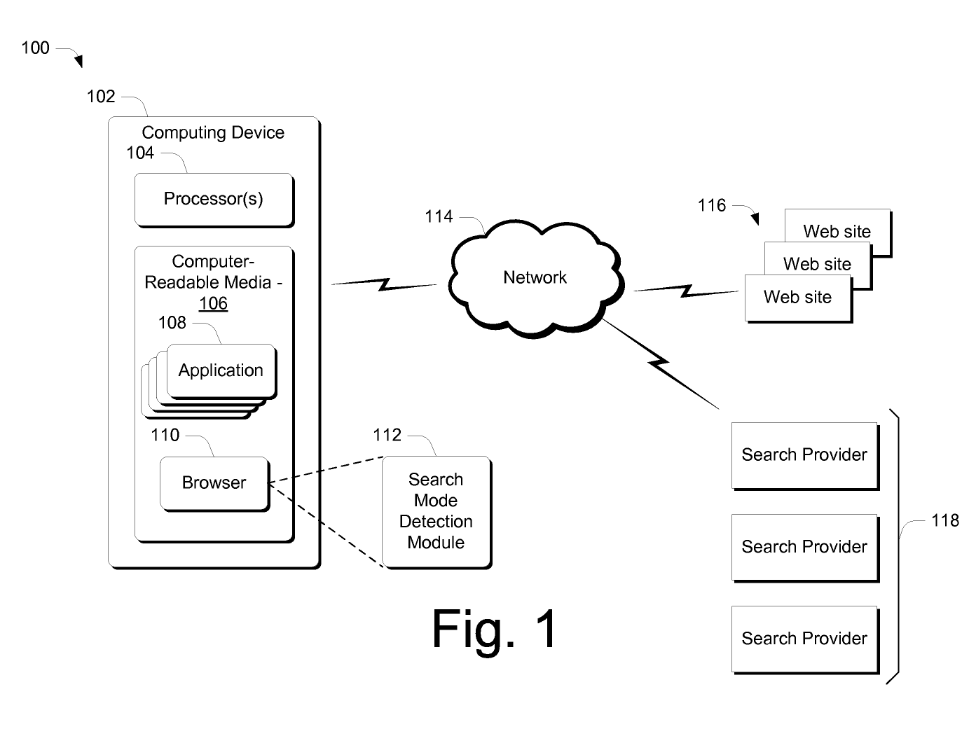

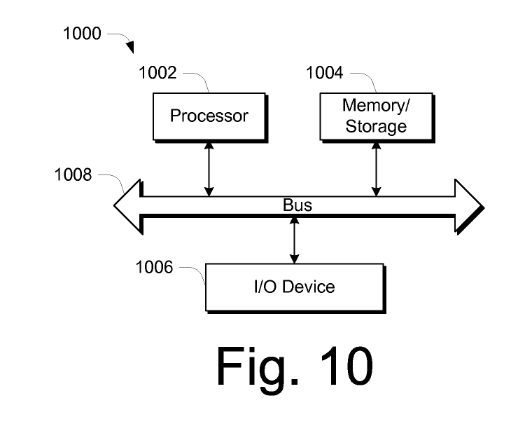

FIG. 1 illustrates an operating environment in accordance with one or more embodiments, generally at 100. Environment 100 includes a computing device 102 having one or more processors 104, one or more computer-readable storage media 106 and one or more applications 108 that reside on the computer-readable storage media and which are executable by the processor(s). The computer-readable storage media can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 10.

In addition, computing device 102 includes a software application in the form of a web browser 110. Any suitable web browser can be used examples of which are available from the assignee of this document and others. In addition, computer-readable storage media 106 can include a search mode detection module 112 that operates as described above and below. In one or more embodiments, the search mode detection module is implemented in connection with a suitably-configured address bar associated with the web browser, as will become apparent below.

In addition, environment 100 includes a network 114, such as the Internet, one or more web sites 116 from and to which content can be received and sent, and one or more search providers 118 that are configured to perform searches, provide suggestions that can be displayed by a web browser, and return search results to browser 110. Website content can include webpage content, such as HTML, script and the like.

In operation, web browser 110 and search mode detection module 112 work in concert to provide users with more control over their navigation privacy, while at the same time offer robust search experiences through a web browser's address bar, as will be described in more detail below.

Computing device 102 can be embodied as any suitable computing device such as, by way of example and not limitation, a desktop computer, a portable computer, netbook, a handheld computer such as a personal digital assistant (PDA), cell phone, and the like.

Having described an example operating environment, consider now a discussion of an example embodiment.

Example Embodiments

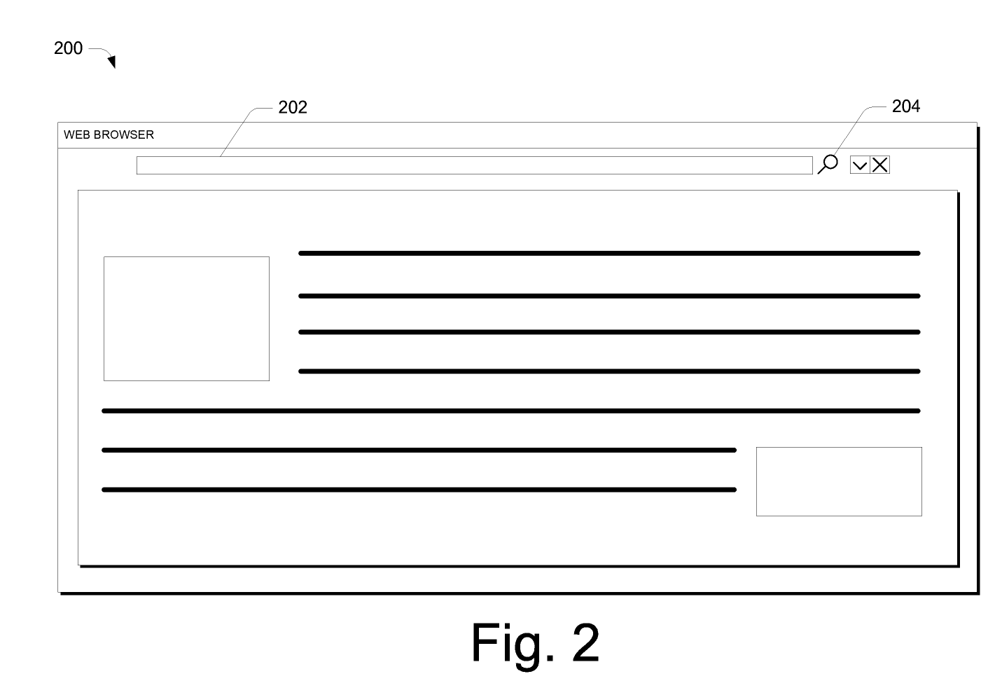

FIG. 2 illustrates an example web browser user interface generally at 200, including an address bar 202. In this particular example, address bar 202 can be used to enable both navigation and search functionality. Users can employ address bar 202 to navigate to particular webpages by entering associated URLs into the address bar. Additionally, users can employ address bar 202 to conduct searches, as by clicking on search glyph 204 to access search mode, and entering searchable text into the address bar that can then be used by a search provider, such as search providers 118 (FIG. 1), to return search results and provide search suggestions.

In the illustrated and described embodiment, as a user types in search text, the text can be provided to a search provider so that the search provider can provide search suggestions that can displayed by the browser and selected by the user.

The embodiments about to be described provide users with more control over their navigation privacy, while offering robust search experiences through a web browser's address bar.

Opting-In to Search Suggestions

Specifically, in one or more embodiments, a web browser's search provider search suggestion functionality is turned off by default. This is to allow users to acknowledge that their keystrokes are kept private by default. By allowing explicit user consent, users know that their keystrokes are available to the search provider. Users may, however, choose to opt into the search provider search suggestion functionality so that search suggestions can be provided to them when they enter search terms in the browser's address bar.

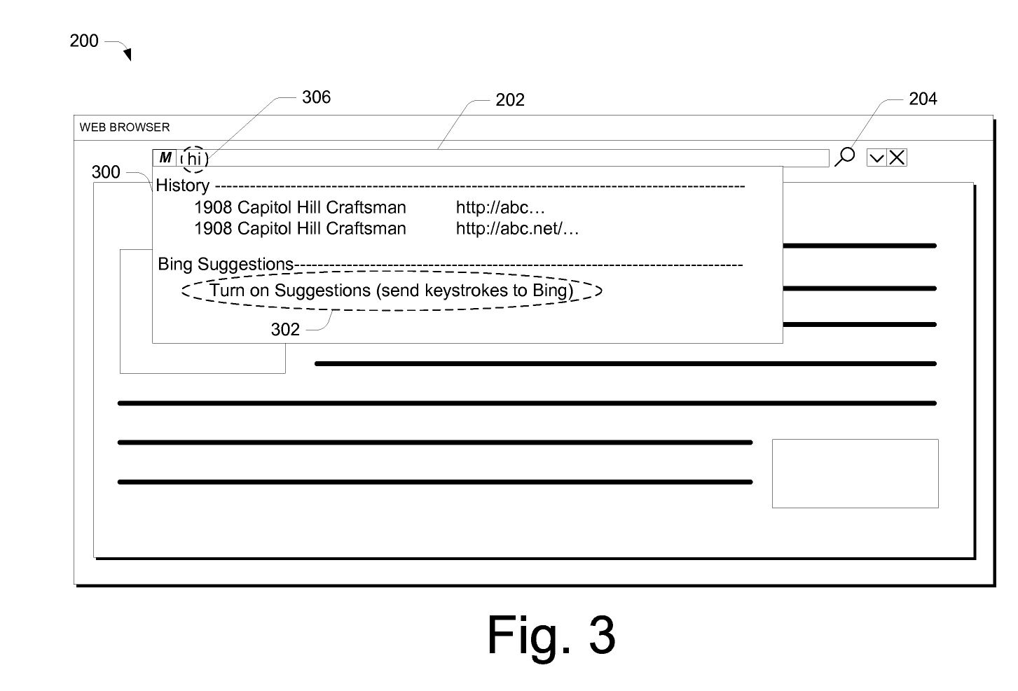

As an example, consider FIG. 3. There, web browser user interface 200, address bar 202, and search glyph 204 are shown. In this particular example, address bar 202 includes an associated drop down menu 300 that can include suggestions that are populated as a user types in text to the address bar 202. Note that suggestions can be provided from multiple sources. For example, suggestions can be provided from local sources, such as a user's history or favorites, which are maintained locally by the web browser. Note also that suggestions that can be provided by search providers, such as Bing™ and others.

In one or more embodiments, the browser functionality that allows suggestions to be provided by search providers is turned off, and users are provided with an opportunity to opt into the functionality. To this end, a link 302 is provided which, when clicked on, turns on the functionality that allows suggestions to be provided by search providers. Note also that the link not only turns on this functionality, but also advises the user, through a message “send keystrokes to Bing”, that their keystrokes are being provided to a selected search provider. Further, address bar 202 includes, as noted above, a glyph 204 that can further allow access to search functionality, as will be described below.

Notice in this example, that a user has typed the text “hi” into the address bar 202 at 306. Correspondingly, suggestions from the user's history are provided in drop-down menu 300 under the heading “History.” Further, because the functionality that allows suggestions from search providers has not been turned on, no suggestions appear in the search provider portion of the drop-down menu entitled “Bing Suggestions.”

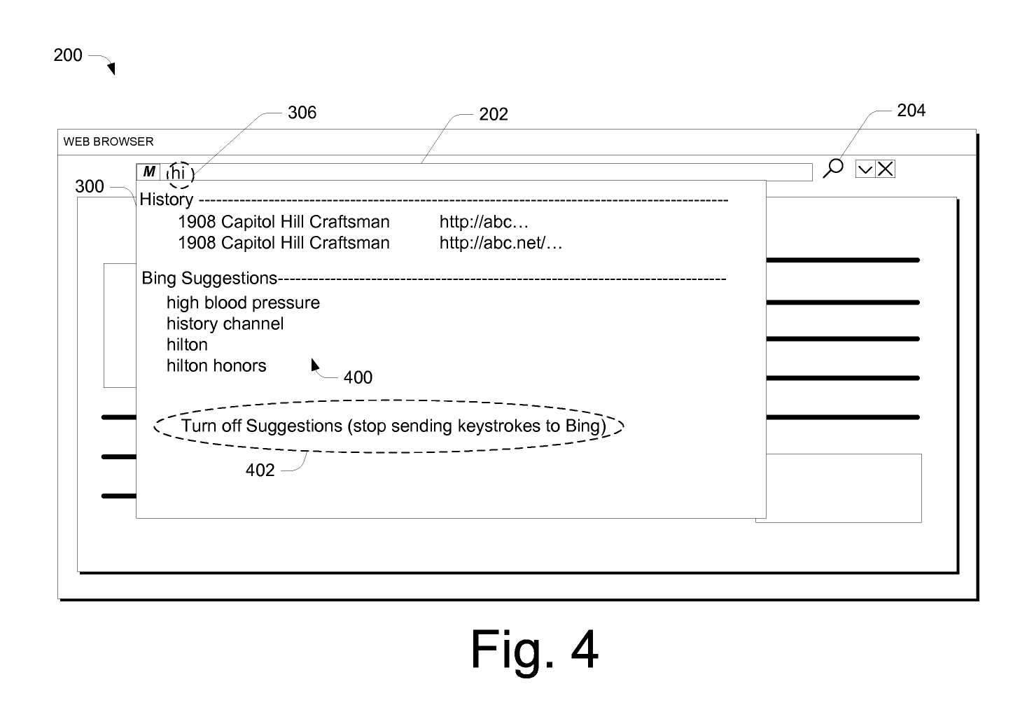

Assume now that a user has clicked on link 302 and opted to turn on the functionality that allows search suggestions to be provided by search providers. As an example, consider FIG. 4 which utilizes like numerical designators to depict like elements from the FIG. 3 example. Responsive to opting into this functionality and typing in the text “hi”, one or more suggestions from the search provider are provided in portion 400 of drop down menu 300. In addition, a link 402 is provided which not only enables the user to opt out of this particular functionality, but also informs the user, through a message “stop sending keystrokes to Bing”, of the action to be taken when this functionality is turned off Collectively, the on-link 302 (FIG. 3) and the off-link 402 remain visible, as appropriate, to inform the user of the state of the search provider suggestion functionality.

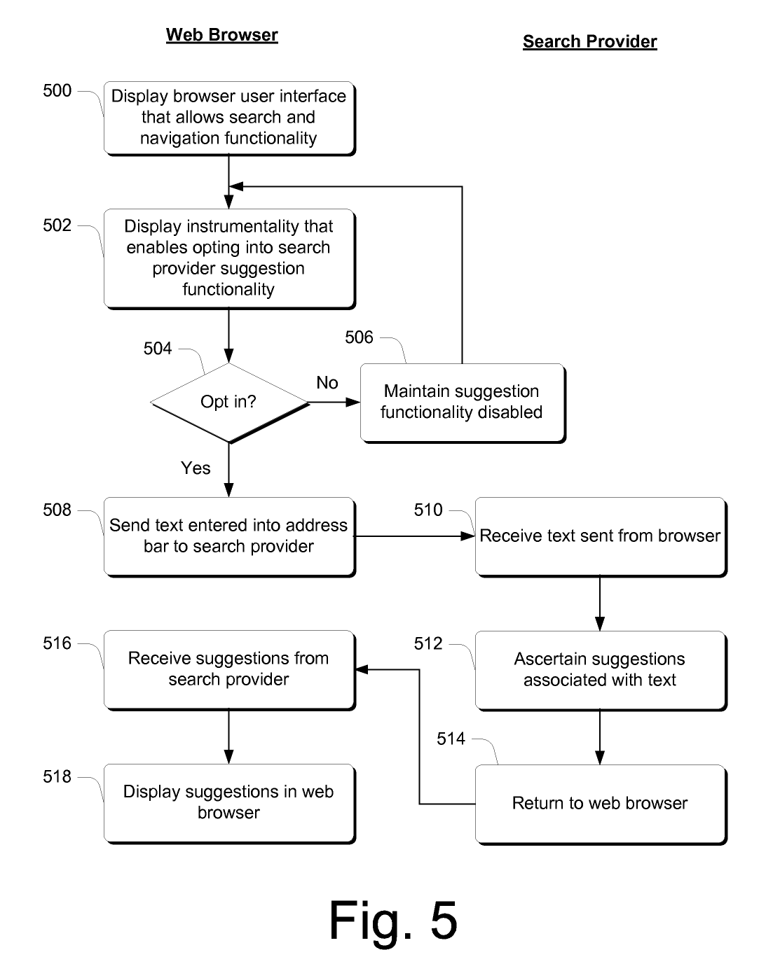

FIG. 5 is a flow diagram that describes steps in a method in accordance with one or more embodiments. The method can be performed in connection with any suitable hardware, software, firmware, or combination thereof In at least some embodiments, aspects of the method can be performed by a suitably-configured web browser, and other aspects can be performed by a suitably-configured search provider. These aspects are designated “Web Browser” and “Search Provider” respectively, in the figure.

Step 500 displays a web browser user interface that allows search and navigation functionality. In the illustrated and described embodiment, the web browser user interface that allows such functionality includes an address bar, such as the one described above, in which text can be entered. Step 502 displays instrumentality that enables opting in to search provider suggestion functionality. This step can be performed when the browser is in search mode and the search provider search suggestion functionality is disabled. Any suitable type of instrumentality can be displayed. In at least some embodiments, and as described above, such instrumentality comprises a link that can be clicked on by user. Step 504 ascertains whether a user has opted into search provider suggestion functionality. If not, step 506 maintains the search suggestion functionality as disabled and returns to step 502. If, on the other hand, step 504 ascertains that a user has opted into the search provider suggestion functionality, step 508 sends text entered into the address bar to a selected search provider. The text that is sent can comprise only a portion of an intended search term such as, by way of example and not limitation, the first few or several letters of a search term.

Step 510 receives the text that is sent from the browser and step 512 ascertains one or more suggestions associated with the text. Step 514 returns the suggestions to the web browser.

Step 516 receives the suggestions from a search provider and step 518 displays the suggestions in the web browser. Examples of how this can be done are provided above.

Having discussed embodiments in which a user can opt into search provider suggestion functionality, consider now various embodiments in which instrumentality is provided in which a user can specifically and explicitly enter either a navigation mode in which no information is sent to a search provider, or a search mode in which search information, such as text, is provided to a search provider that can then return suggestions to the web browser.

Explicit Navigation Mode

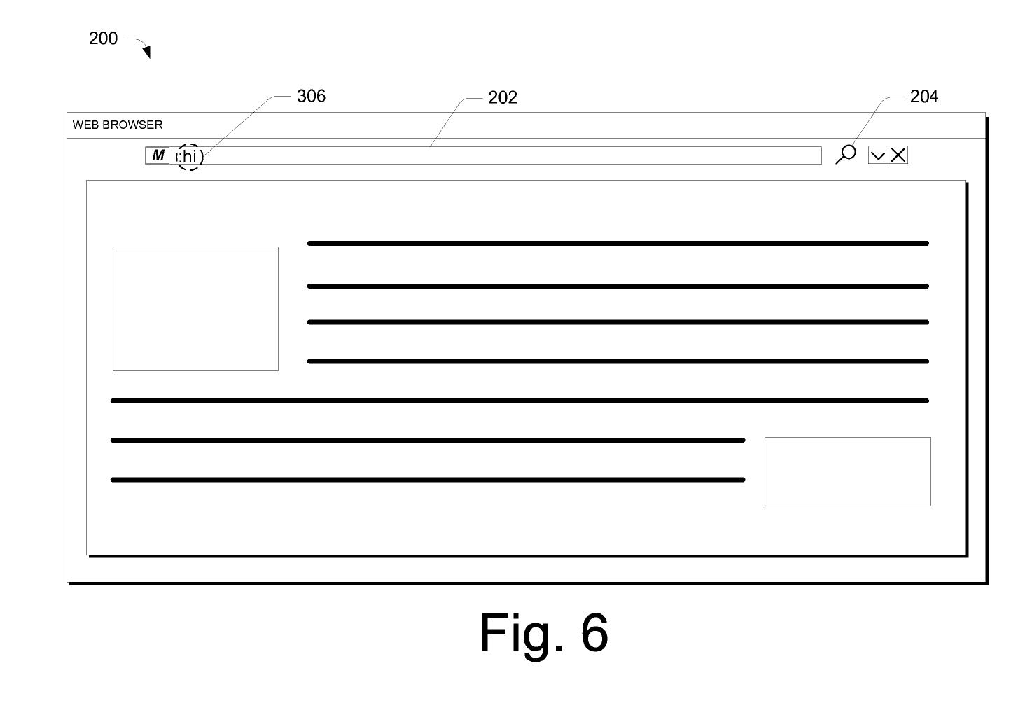

In one or more embodiments, a user can select to be in a navigation mode such that text that is entered in the address bar is not provided to a search provider. As an example, consider FIG. 6 which uses like numerals from the above-described embodiments to depict like components.

In one or more embodiments, a user can employ one or more instrumentalities to explicitly select the navigation functionality or mode. For example, in at least one embodiment an instrumentality in the form of a special text character or symbol can be employed. In the FIG. 6 example, the character or symbol “:” is used and is typed in prior to the term “hi”. This tells the browser that the navigation mode is desired and not the search mode. Correspondingly, the search provider suggestion functionality is disabled for this particular entry until it is re-enabled.

Alternately or additionally, to select the navigation mode and not the search mode, an instrumentality in the form of a set of keystrokes, such as a hot key combination and can be utilized. Correspondingly, when the set of keystrokes is received, the search provider suggestion functionality is disabled for this particular entry until it is re-enabled.

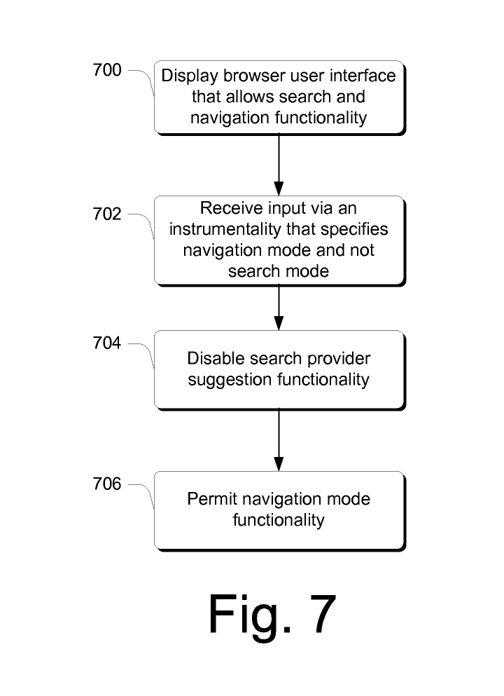

FIG. 7 is a flow diagram that describes steps in a method in accordance with one or more embodiments. The steps can be performed in connection with any suitable hardware, software, firmware, or combination thereof In at least some embodiments, the method can be performed by a suitably-configured web browser such as that described above.

Step 700 displays a browser user interface that allows search and navigation functionality. In the illustrated and described embodiment, the web browser user interface that allows such functionality includes an address bar such as the one described above. Step 702 receives input via an instrumentality that specifies navigation mode and not search mode. Any suitable type of instrumentality can be utilized. In the illustrated and described embodiments, instrumentalities in the form of a special character or symbol and/or a special key combination can be used.

Responsive to receiving the input via the instrumentality, step 704 disables the search provider suggestion functionality. By doing so, text that is entered into the browser's address bar is not sent to a search provider. Accordingly, step 706 permits navigation mode functionality while the search provider suggestion functionality is disabled.

Explicit Search Mode

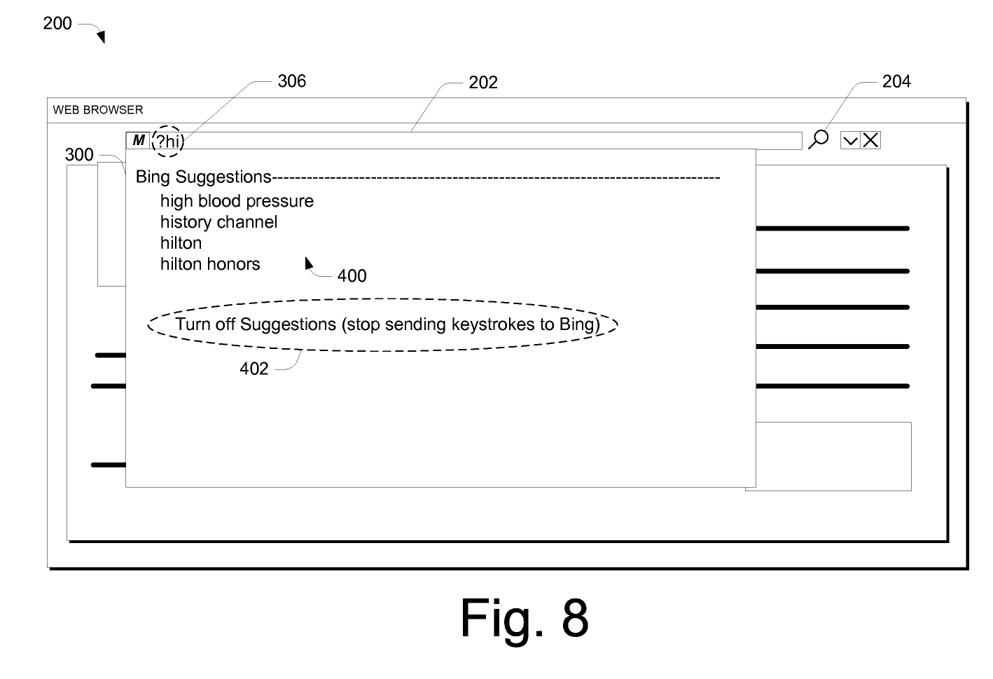

In one or more embodiments, a user can select to be in search mode and not navigation mode such that text that is entered in the address bar is provided to a search provider. As an example, consider FIG. 8 which uses like numerals from the above-described embodiments to depict like components.

In one or more embodiments, a user can employ one or more instrumentalities to explicitly select the search functionality or mode. For example, in at least one embodiment an instrumentality in the form of a special text character or symbol can be employed. In the FIG. 8 example, the character or symbol “?” is used and is typed in prior to the term “hi”. This tells the browser that the search mode is desired and not the navigation mode. Correspondingly, the search provider suggestion functionality is enabled for this particular entry until it is dis-enabled. Correspondingly, dropdown menu 300 includes a plurality of suggestions from the search provider as in the above example.

Alternately or additionally, to select search mode and not the navigation mode, an instrumentality in the form of a set of keystrokes, such as a hot key combination and can be utilized. Correspondingly, when the set of keystrokes is received, the search provider suggestion functionality is enabled for this particular entry until it is disabled.

Alternately or additionally, to enter the search mode, the glyph 204 can be clicked to automatically select search mode and/or toggle the browser between search mode and a hybrid navigation/search mode.

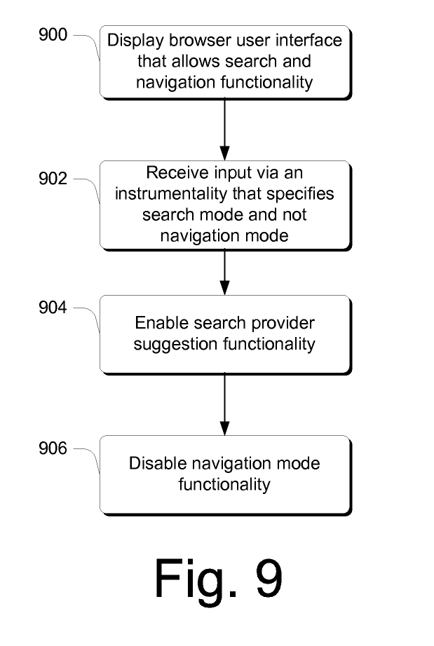

FIG. 9 is a flow diagram that describes steps in a method in accordance with one or more embodiments. The steps can be performed in connection with any suitable hardware, software, firmware, or combination thereof. In at least some embodiments, the method can be performed by a suitably-configured web browser such as that described above.

Step 900 displays a browser user interface that allows search and navigation functionality. In the illustrated and described embodiment, the web browser user interface that allows such functionality includes an address bar such as the one described above. Step 902 receives input via an instrumentality that specifies search mode and not navigation mode. Any suitable type of instrumentality can be utilized. In the illustrated and described embodiments, instrumentalities in the form of a special character or symbol, a special key combination, or a special glyph that appears in the address bar can be used.

Responsive to receiving the input via the instrumentality, step 904 enables the search provider suggestion functionality. By doing so, text that is entered into the browser's address bar is sent to a search provider so that suggestions can be received as described above. Accordingly, step 906 disables navigation mode functionality while the search provider suggestion functionality is enabled.

Having described embodiments in which the user can specify navigation mode or search mode to the exclusion of the other, consider now embodiments in which a search query can be continued.

Continuing a Search Query

In various other embodiments, functionality is provided to enable a search query to continue within a browser window when, for example, a user changes browser modes or returns to the address bar to further their search.

For example, assume a situation in which a search entry has been provided into the address bar and a returned search results page which has been navigated through by the user. In addition, assume that the user navigated to other pages. If the user wants to further their previous search, they can simply click glyph 204 (FIG. 8) and their previous search for the session will be populated and highlighted in the address bar. This enables a scenario where, for example, the user typed in “walrus”, navigated away but wants to refine the search. By simply clicking on the glyph or using a hot key combination, their previous search will be populated in the address bar as “?walrus”, thus saving the user from having to re-type their previous search.

Assume now that the user has typed into the address bar but has not committed the result. The current text can be used as the search query and highlighted. This enables the scenario where, for example, the user first searches on “walrus” and now wants to search for something completely different like “hill”. They can simply type the new search term without having to perform a delete operation.

Accordingly, a user's search can be continued in a number of different ways using in the browser's address bar and, in some instances, an associated search glyph.

It is to be appreciated and understood, that in at least some embodiments, the above-described functionality is provided per browser window. That is, once a browser window is closed, the previous search queries are flushed from the system. In addition, such functionality can be constrained so that it operates per browser frame and not across different instances of the same browser.

Having described various embodiments, consider now an example system that can be utilized to implement one or more of the above-described embodiments.

Example System

FIG. 10 illustrates an example computing device 1000 that can be used to implement the various embodiments described above. Computing device 1000 can be, for example, computing device 102 of FIG. 1 or any other suitable computing device.

Computing device 1000 includes one or more processors or processing units 1002, one or more memory and/or storage components 1004, one or more input/output (I/O) devices 1006, and a bus 1008 that allows the various components and devices to communicate with one another. Bus 1008 represents one or more of any of several types of bus structures, including a memory bus or memory controller, a peripheral bus, an accelerated graphics port, and a processor or local bus using any of a variety of bus architectures. Bus 1008 can include wired and/or wireless buses.

Memory/storage component 1004 represents one or more computer storage media. Component 1004 can include volatile media (such as random access memory (RAM)) and/or nonvolatile media (such as read only memory (ROM), Flash memory, optical disks, magnetic disks, and so forth). Component 1004 can include fixed media (e.g., RAM, ROM, a fixed hard drive, etc.) as well as removable media (e.g., a Flash memory drive, a removable hard drive, an optical disk, and so forth).

One or more input/output devices 1006 allow a user to enter commands and information to computing device 1000, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer-readable storage media”.

“Computer-readable storage media” include volatile and non-volatile, removable and non-removable media implemented in any method or technology for storage of information such as computer readable instructions, data structures, program modules, or other data. Computer-readable storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Conclusion

Various embodiments are directed to providing users with more control over their navigation privacy, while offering robust search experiences through a web browser's address bar.

In one or more embodiments, a web browser's search provider search suggestion functionality is turned off by default. Users may choose to opt into the search provider search suggestion functionality so that search suggestions can be provided to them by the search provider when they enter search terms in the browser's address bar. In one or more embodiments, the status of search provider search suggestion functionality is conveyed to the user so that they understand that their keystrokes are being provided to a search provider so that search suggestions can, in turn, be provided back to the web browser.

In various other embodiments, instrumentality is provided in which a user can specifically and explicitly enter either a navigation mode in which no information is sent to a search provider, or a search mode in which search information is provided to a search provider that can then return suggestions to the web browser.

In various other embodiments, functionality is provided to enable a search query to continue within a browser window when, for example, a user changes browser modes or returns to the address bar to further their search.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims

What is claimed is:

1. A computer-implemented method comprising:
displaying a web browser user interface that allows search and navigation functionality from within an address bar;
displaying instrumentality that enables opting into search provider suggestion functionality;
ascertaining whether a user has opted into the search provider suggestion functionality through input via the instrumentality;
responsive to a user opting into the search provider suggestion functionality, sending text entered into the address bar to a selected search provider;
receiving suggestions associated with the text from a search provider; and
displaying the suggestions in the web browser.

2. The computer-implemented method of claim 1, wherein said displaying instrumentality comprises displaying a link.

3. The computer-implemented method of claim 1, wherein the instrumentality is configured to display a message associated with providing keystrokes to a search provider.

4. The computer-implemented method of claim 1 further comprising maintaining search provider suggestion functionality disabled in an event such functionality has not been opted into.

5. The computer-implemented method of claim 1 further comprising responsive to search provider suggestion functionality being opted into, displaying different instrumentality that enables opting out of search provider suggestion functionality.

6. The computer-implemented method of claim 1 further comprising responsive to search provider suggestion functionality being opted into, displaying different instrumentality that enables opting out of search provider suggestion functionality, wherein displaying different instrumentality comprises displaying a different link.

7. The computer-implemented method of claim 1 further comprising responsive to search provider suggestion functionality being opted into, displaying different instrumentality that enables opting out of search provider suggestion functionality, wherein the different instrumentality is configured to display a message associated with an action to be taken when search provider's suggestion functionality is disabled.

8. One or more computer readable storage media embodying computer readable instructions which, when executed, implement a method comprising:
displaying a user interface that allows search and navigation functionality from within an address bar;
receiving input via an instrumentality that specifies navigation functionality and not search functionality;
responsive to receiving the input via the instrumentality, disabling search provider suggestion functionality; and
permitting navigation functionality, via the address bar, while the search provider suggestion functionality is disabled.

9. The one or more computer readable storage media of claim 8, wherein said instrumentality comprises a special character or symbol.

10. The one or more computer readable storage media of claim 8, wherein said instrumentality comprises a special key combination.

11. The one or more computer readable storage media of claim 8, wherein said disabling comprises not sending text that is entered into the address bar to a search provider.

12. The one or more computer readable storage media of claim 8, wherein said displaying, receiving, disabling, and permitting are performed by a web browser.

13. One or more computer readable storage media embodying computer readable instructions which, when executed, implement:
a search mode detection module configured to:
display a web browser user interface that allows search and navigation functionality via an address bar;
receive input via an instrumentality that specifies a search functionality and not a navigation functionality;
responsive to receiving the input via the instrumentality, enable search provider suggestion functionality in which text that is entered into the address bar is sent to a search provider so that suggestions can be received from the search provider; and
disable navigation functionality while the search provider suggestion functionality is enabled.

14. The one or more computer-readable storage media of claim 13, wherein the instrumentality comprises a special character or symbol.

15. The one or more computer-readable storage media of claim 13, wherein instrumentality comprises a special key combination.

16. The one or more computer-readable storage media of claim 13, wherein the instrumentality comprises a glyph.

17. The one or more computer-readable storage media of claim 13, wherein the instrumentality comprises a glyph, and wherein the search mode detection module is configured to receive the input via the instrumentality after text has been typed into the address bar.

18. The one or more computer-readable storage media of claim 13, wherein the search mode detection module is further configured to continue a search query by populating a previous search in the address bar.

19. The one or more computer-readable storage media of claim 13, wherein the search mode detection module is further configured to continue a search query by populating a previous search in the address bar, and wherein the search mode detection module is configured to continue the search query via a glyph in the address bar.

20. The one or more computer-readable storage media of claim 13, wherein the search mode detection module is further configured to continue a search query by populating a previous search in the address bar, and wherein the search mode detection module is configured to continue the search query via a key combination.
